(19) United States
(12) Patent Application Publication
(10) Pub. No.: US 2004/0099997 A1
(43) Pub. Date: May 27, 2004

(54) Reheat stretch blow-molding process for polypropylene

(75) Inventors: David A. Bogstad, Perrysburg, OH (US); Thomas J. Carros, Holland, OH (US); Craig A. Peabody, Toledo, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(73) Assignee: Plastic Technologies, Inc., Holland, OH

(21) Appl. No.: 10/716,226

(22) Filed: Nov. 18, 2003

Related U.S. Application Data
(60) Provisional application No. 60/427,520, filed on Nov. 19, 2002.

(51) Int. Cl. B29C 49/64

(52) U.S. Cl. 264/458; 264/535

(57) ABSTRACT

A reheat stretch blow-molding process comprises providing a polypropylene preform, and heating the preform utilizing a plurality of infrared energy sources positioned adjacent-said preform at distances inversely proportional to the wall thickness of said preform directly apposing said infrared energy sources.

### CROSS-REFERENCE TO RELATED APPLICATION

This application claims the benefit of U.S. provisional patent application Serial No. 60/427,520, filed Nov. 19, 2002.

### FIELD OF THE INVENTION

The present invention relates generally to a reheat stretch blow-molding process for polypropylene. More particularly, the invention is directed to processing guidelines for reheating a polypropylene preform prior to stretch blow-molding it into a container.

### BACKGROUND OF THE INVENTION

It is well known that polypropylene may be used to form a container, for packaging beverages, food products, dry materials, medicines, and the like. Unlike polyester containers, which can retain their dimensional characteristics under pressure, polypropylene containers have traditionally been used to hold materials under less severe conditions. Polypropylene containers exhibit poor dimensional stability under stress, and therefore have been utilized for less demanding service.

Recently, polypropylene containers have posed a challenge to more traditional packaging materials, and in some cases have emerged as the containers of preference for specific applications.

It would be desirable to develop a process to reheat stretch blow mold polypropylene in a manner that improves the mechanical and physical properties of the ultimately produced polypropylene container.

### SUMMARY OF THE INVENTION

Accordant with the present invention, there surprisingly has been discovered an improved reheat stretch blow-molding process employing polypropylene.

It comprises:

providing a polypropylene preform; and

heating the preform, utilizing a plurality of infrared energy sources positioned adjacent said preform at distances inversely proportional to the wall thickness of said preform directly apposing said infrared energy sources.

The reheat stretch blow-molding process according to the present invention is particularly useful for producing containers for packaging beverages, food products, dry material, medicines, and the like.

### DETAILED DESCRIPTION OF THE PREFERRED EMBODIMENT

A process for reheat stretch blow-molding polypropylene containers comprises providing a polypropylene preform, and heating the-preform utilizing a plurality of infrared energy sources positioned adjacent said preform at distances inversely proportional to the wall thickness of said preform directly apposing said infrared energy sources.

Conventional methods for reheat stretch blow-molding a container from a polypropylene preform are known. A preform is formed by injection molding polypropylene. Subsequently, the preform is reheated by means of a plurality of infrared energy sources, and thereafter simultaneously stretched and blown into conformity with the surface of a mold cavity.

The polypropylene useful for practicing the present invention may comprise high, medium, or low-density polypropylene, as well as blends and copolymers of polypropylene with other polymers. Furthermore, the polypropylene according to the present invention may contain conventional adjuvants such as, for example, clarifiers, fillers, extenders, lubricants, infrared energy absorbing agents, and the like.

The geometry of a typical perform reheating system influences the heat-pattern along the length of the preform. A typical preform has variations in wall thickness along its length, to accommodate the variations in the configuration-of the ultimately produced blow molded container.

The preform must attain a precise, uniform temperature at which the polypropylene may be formed. In some instances, a temperature profile must be imposed on the preform, so that certain regions of the preform will stretch more at a higher rate, in order to fill extended mold cavities during the reheat stretch blow-molding process.

In either case, it has been determined that improved mechanical and physical properties may be instilled in the ultimately-produced container by heating the polypropylene preform utilizing a plurality of infrared energy emitting heat lamps which are positioned in an array adjacent the preform, wherein the distances between each individual heat lamp and the preform are inversely proportional to the wall thickness of the preform directly apposing each heat lamp.

The positioning of the infrared energy sources according to the present invention is contrary to and essentially opposite from the conventional placement of these same infrared energy sources for the well-known process of reheating polypropylene terephthalate preforms.

Following the reheating process according to the present invention, the properly reheated polypropylene preform is positioned within the mold cavity of a conventional stretch blow-molding apparatus. The preform is then stretched axially by employing an internal stretch rod that engages the closed end of the preform. Simultaneously, the preform is stretched radially by introducing internal blowing gas at the open end of the preform until the preform is forced into conformity with the walls of the mold cavity. Alternatively, the axial stretching and radial blowing may be carried out sequentially. The stretched, formed polypropylene preform is thereby rapidly quenched by contact against the mold cavity surface, to prepare a reheat stretch blow molded container.

From the foregoing description, one ordinarily skilled in the art can easily ascertain the essential characteristics of this invention and, without departing from its spirit and scope, can make various changes and modifications to adapt the invention to various uses and conditions.

What is claimed is:

1. A reheat stretch blow-molding process, comprising:
preparing a polypropylene preform; and
heating the preform, utilizing a plurality of infrared energy sources positioned adjacent said preform at distances inversely proportional to the wall thickness of said preform directly apposing said infrared energy sources.

2. The reheat stretch blow-molding process according to claim 1, wherein the polypropylene comprises polypropylene selected from the group consisting of high, medium, and low-density polypropylene.

3. The reheat stretch blow-molding process according to claim 1, wherein the polypropylene contains one or more adjuvants selected from the group consisting of clarifiers, fillers, extenders, lubricants, and infrared energy absorbing agents.

4. The reheat stretch blow-molding process according to claim 1, wherein the infrared energy sources are closest to the preform wall apposite a portion of the preform having the greatest thickness.

5. The reheat stretch blow-molding process according to claim 1, wherein the infrared energy sources comprise heat lamps.

6. A reheat stretch blow-molding process, comprising:
preparing a polypropylene preform, said polypropylene selected from the group consisting of high, medium, and low density polypropylene, said polypropylene containing one or more adjuvants selected from the group consisting of clarifiers, fillers, extenders, lubricants, and infrared energy absorbing agents; and
heating the preform, utilizing a plurality of infrared energy sources positioned adjacent said preform at distances inversely proportional to the wall thickness of said preform directly apposing said infrared energy sources, wherein the infrared energy sources are closest to the preform wall adjacent a portion of the preform having the greatest thickness.

7. The reheat stretch blow-molding process according to claim 6, wherein the infrared energy sources comprise heat lamps.
